(19) United States
(12) Patent Application Publication
(10) Pub. No.: US 2008/0115556 A1
(43) Pub. Date: May 22, 2008

(54) Emergency Flow Stoppage Tool

(76) Inventor: Thomas Hughes, Hasting on Hudson, NY (US)

Correspondence Address: JACKIE JAY SCHWARTZ, 1350 Broadway, Suite 1510, NEW YORK, NY, 10018, US

(21) Appl. No.: 11/696,446

(22) Filed: Apr. 4, 2007

Related U.S. Application Data
(60) Provisional application No. 60/860,612, filed on Nov. 22, 2006.
(60) Provisional application No. 60/872,318, filed on Dec. 2, 2006.

(51) Int. Cl. B25B 7/12

(52) U.S. Cl. 72/409.11

(57) ABSTRACT

A tool reduces a flow of liquid or gas through a conduit. The tool includes a crimping section having a first crimping member with a first blunt section extending partially along an edge thereof and a second crimping member having a second blunt section extending partially along an edge thereof. The first and second members are pivotally engaged with one another. A handle section is connected to the crimping section. The handle section includes a first handle member connected to the first crimping member and a second handle member connected to the second crimping member. A hinge pivotally connects the first handle member to the second handle member. When the first and second handle members are pivoted about the hinge, the first and second crimping members are caused to pivot in a direction opposite to the respective first and second handle members.

### CROSS-REFERENCE TO RELATED APPLICATIONS

This is a Non-Provisional Patent Application that claims priority from Provisional Patent Application Serial No. 60/860,612 filed on Nov. 22, 2006 and Provisional Patent Application Serial No. 60/872,318 filed on Dec. 2, 2006.

### FIELD OF THE INVENTION

The present invention relates to tools and, more specifically, to a tool for selectively preventing the flow of liquid and/or gas through a conduit.

### BACKGROUND OF THE INVENTION

In the construction and contracting industry, different groups of people work on different areas of a project in order to build or repair a structure. The structure typically has many component systems such as structural components, electrical systems, heating and ventilation systems and plumbing. Each of these systems are designed to perform certain functions but, when working together, combine to provide for a fully functional structure. When building or repairing these structures, accidents or failures in existing systems may occur where one system is interrupted or damaged while working on it or on a different system. In the event that the damage occurs to the plumbing or piping system, the damage resulting therefrom may be extensive. For example, water flowing out of a damage area of a live pipe could damage the structural or electrical systems as well as building finishes (furniture, carpeting, etc) and personal items which are proximate to the cracked pipe. Additionally, another problem occurs when the structure is large in scale (a high-rise building, for example) and the location of the emergency shut off for the plumbing system may be far away from the damaged piping, difficult to find or inoperable. This may lead to prolonged exposure and extensive damage to the structure from any liquids traveling out from the damaged section of a live pipe. Therefore, a need exists for a tool for selectively stopping or reducing the flow of liquid or gas through a conduit to reduce and/or stop the flow of the liquid or gas out of the damage section of the pipe which will quickly prevent and/or reduce the damage to the surrounding structure, systems, finishes and other items positioned nearby. There is a further need to provide a tool that does not sever or cut the conduit but rather closes off the conduit to prevent any additional water or liquid from passing therethrough. A tool according to the invention principles satisfies these needs and remedies the above-noted drawbacks.

### SUMMARY OF THE INVENTION

A tool reduces a flow of liquid or gas through a conduit. The tool includes a crimping section having a first crimping member with a first blunt section extending partially along an edge thereof and a second crimping member having a second blunt section extending partially along an edge thereof. The first and second members are pivotally engaged with one another. A handle section is connected to the crimping section. The handle section includes a first handle member connected to the first crimping member and a second handle member connected to the second crimping member. A hinge pivotally connects the first handle member to the second handle member. When the first and second handle members are pivoted about the hinge, the first and second crimping members are caused to pivot in a direction opposite to the respective first and second handle members.

A liquid and/or gas flow stoppage tool includes a handle section, a mid section and a crimping section. The crimping section is connected to the mid section at a first end thereof. The handle section is connected to the mid section at an end opposite the first end. The crimping section includes a first and second crimping member each having a respective crimping edge. The first and second crimping members are pivotally connected to one another such that the crimping edges are adjacent and face one another. The middle section includes a first and second leg. The first and second crimping members are connected via hinges to the first and second legs of the middle section, respectively. The first and second leg of the middle section may be pivotally connected to one another by a bolted male female connection. The handle section includes a first gripping member and a second gripping member. The mid section may include a locking mechanism for selectively locking the crimping section around a conduit positioned between the crimping members to further maintain a substantial reduction or full flow stoppage. Additionally, each gripping member may be selectively removeable from the crimping section.

An object of the flow stoppage tool is to provide a portable tool for use in stopping the flow of liquid and/or gas through a conduit by crimping the conduit between two crimping members. The tool may be gripped by a user with two hands such that when force is applied to the gripping members of the handle section, the crimping member is caused to squeeze the conduit therebetween and effectively close the conduit. The crimping members may be locked in place ensuring a substantial reduction in flow or full flow stoppage. The gripping members can each be removed from the tool to reduce the amount of weight being held by the conduit. The removal of the gripping members advantageously prevents further damage to the weakened or cracked conduit due to the weight of the tool. The flow stoppage tool provides a temporary solution for minimizing damage associated with a cracked conduit thereby providing a user enough time to find a permanent manner to stop the flow through the conduit.

A method for stopping the flow of liquid or gas through a conduit includes gripping a crimping tool. The crimping tool includes a crimping section, a mid section and a handle section. The crimping section includes the first and second crimping members each having a crimping edge. The crimping members are pivotally connected to each other and also connected via respective pivotal connections to the mid section. The handle section includes a first gripping member and a second gripping member each connected to the mid section by a male/female bolted connection or any other connection mechanism that allows for a releasable connection between the midsection and the handle section. The griping members are moved in to an open position separated from one another causing the crimping members to move or pivot apart from one another creating a space therebetween. The user selectively positions a conduit in the space between the crimping members and moves the gripping members toward one another. The crimping members are caused to pivot about the hinge causing the crimping members to pivot toward each other whereby crimping edges of the crimping members engage and crimp the conduit positioned therebetween reducing or stopping the flow of liquid and/or gas through the conduit.

### BRIEF DESCRIPTION OF THE DRAWINGS

In order that the invention may be more fully understood, it will now be described, by way of example, with reference to the accompanying drawing in which:

FIG. 1 is a front view of the emergency flow stoppage tool according to invention principles;

FIG. 2 is a side view of the emergency flow stoppage tool shown in FIG. 1 according to invention principles;

FIG. 3 is an exploded side view of the emergency flow stoppage tool according to invention principles;

FIG. 4 is front view of the crimping section of the emergency flow stoppage tool according to invention principles;

FIG. 5 is a front view of the emergency flow stoppage tool in an open position according to invention principles;

FIG. 6 is a front view of the of the emergency flow stoppage tool according to invention principles including an alternate pivotal connection between the legs of the handle section;

FIG. 7 is a side view of the emergency flow stoppage tool shown in FIG. 6 according to invention principles;

FIG. 8 is a flow diagram detailing the operation of the emergency flow stoppage tool according to invention principles;

FIGS. 9-11 are front views of the crimping section of the tool according to invention principles showing additional crimping member configurations, and

FIG. 12 is a cross sectional view of the crimping section of the tool taken along the line labeled X-X in FIGS. 9-11.

### DETAILED DESCRIPTION

The following discussion describes in detail the invention. This discussion should not be construed, however, as limiting the invention to that particular embodiment. Practitioners skilled in the art will recognize numerous other embodiments as well.

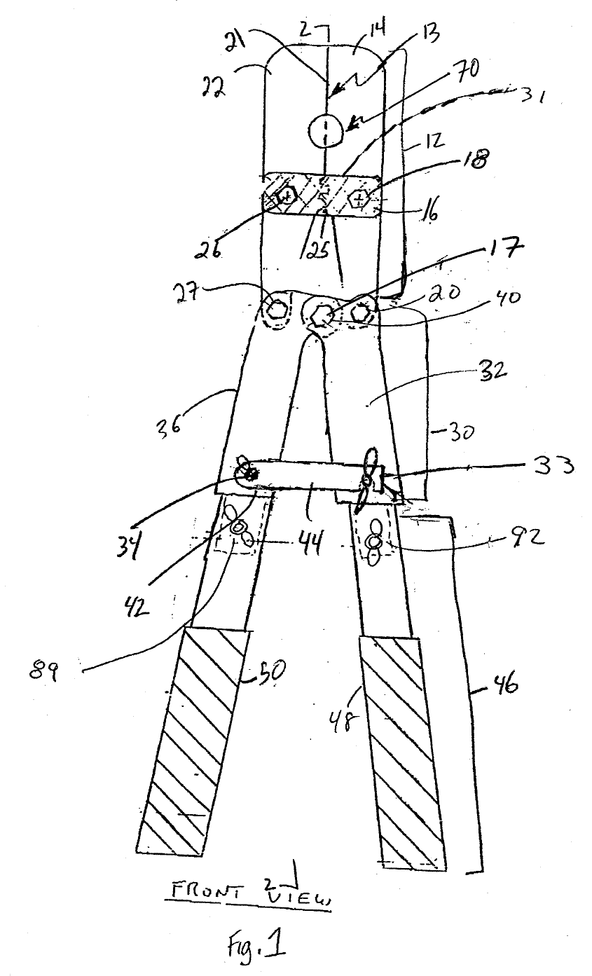

Turning now to the drawings, in which similar reference characters denote similar elements throughout the several views, FIGS. 1 through 6 illustrate an emergency flow stoppage tool which is indicated generally by the reference numeral 10.

The emergency flow stoppage tool 10 shown in FIGS. 1-5 may be a hand-held and hand operated tool for use in quickly reducing or preventing the undesired flow of liquids, gases or other substances through a conduit that is cracked or broken. The term conduit as used herein may define a pipe, tube, duct or any other structure able to transport a liquid or a gas. The terms liquid and gas may be used interchangeably throughout the application and also may include any other substance readily transportable via a conduit. The tool 10 crimps a small section of the conduit upstream from the damaged section. The crimping action performed by the tool substantially reduces or prevents the flow of liquid through the damaged section of the conduit. Alternatively the tool 10 may be used to either stop the flow of liquid in a non-damaged pipe or to narrow the opening of the conduit such that the amount of liquid passing through the conduit is reduced thereby reducing the rate at which the liquid flows through a section of the conduit. The use of tool 10 on a non-damaged pipe is anticipated in piping/conduit systems that do not have typical shut down or flow control devices or that may have such devices but are not working properly.

The tool is designed to be portable and easy to use by a user of any skill level. For example, the tool may be advantageously used by contractors working on building sites where accidental damage to pipes may occur. Upon operation of the tool, the contractor would be able to easily and quickly seal off a pipe that has cracked or burst to prevent damage to the surrounding structure. Additionally, the tool may be used in the home in the event a pipe in any area of the home breaks. The tool will apply enough force to the walls of the pipe to crimp the section upstream from the break or crack to allow the user enough time to locate and activate any shut-off mechanism. Crimping the pipe upstream from the damaged section prevents the flow of any liquid or gas from reaching the damaged section of the pipe and flowing out therefrom. Alternatively, the tool may be used as the shut-off mechanism when there is no mechanism present.

FIG. 1 is a front view of the tool 10 for use in crimping a conduit that has either liquid or gas flowing therethrough. The tool includes a crimping section 12, a middle section 30 and a handle section 46. The crimping section 12 and the handle section 46 are connected to opposing ends of the middle section 30 in the manner discussed below. The middle section 30 includes a first leg 32 and a second leg 36. The first leg 32 and second leg 36 each include a mating recess 40 at an end thereof. A connection pin 17 extends through the mating recesses 40 of both the first and second legs 32, 36 to form a connection about which the first and second legs 32, 36 pivot. The connection pin 17 may include a nut and bolt assembly or any other mechanism that allows a pivotal connection to be formed between the first and second legs 32, 36 respectively. The crimping section 12 is connected to the middle section 30 at connection points at either side of the pivotal connection about which the first and second leg 32, 36 pivot.

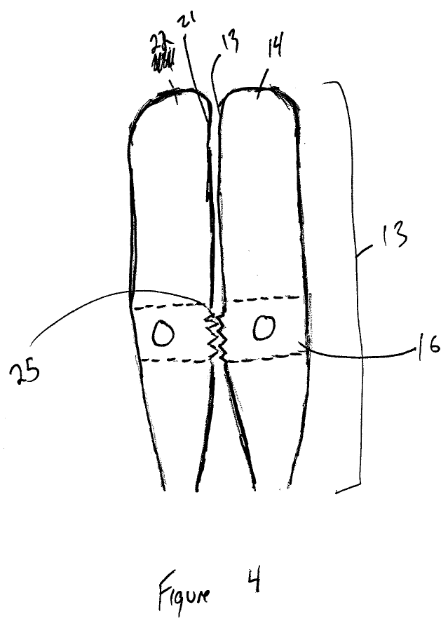

The crimping section 12 includes a first arm 14 having a first crimping edge 13 connected to the first leg 32 via a first connection hinge 20. A second arm 22 having a second crimping edge 21 is connected to the second leg 36 via a second connection hinge 27. At the base of the crimping edges 13 and 21, as shown in FIG. 4, arc shaped sections having a plurality of teeth extends outward therefrom and form a geared area 25 therebetween. The first arm 14 and the second arm 22 are held together at their geared area 25 by a double plated assembly 31. The first and second arms 14 and 22 have a first width at the point of connection to the first and second legs 32 and 36, respectively. The width of the arms 14 and 22 gradually increase in direction opposite the connection point to have a second width, greater than the first width beginning at the base of the crimping edges 13 and 21. The gradual increase in width between the first and second widths enables the crimping members to pivot about the geared section 25 and create an opening between the crimping edges 13 and 21. The width of the arms 14 and 22 may remain constant or may gradually decrease such that an edge opposite the crimping edges 13 and 21 is rounded. Additionally, the width and thickness of each of the first and second arms 14 and 22 should be sufficient so as to prevent any deformation thereof when crimping force is applied to the handle section 46 and transferred to the crimping section 12 via the middle section 30. Furthermore,

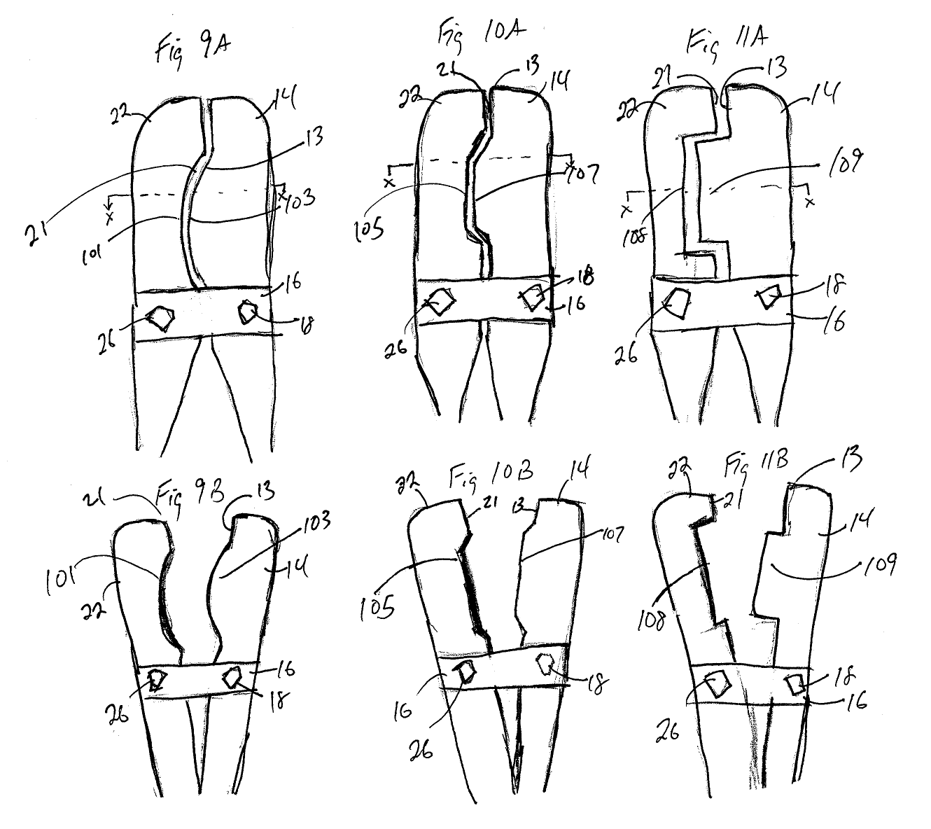

The crimping edges 13, 21 are substantially flattened or blunt and are positioned facing one another when the tool 10 is in a closed or engaged position. The edges 13 and 21 may be blunt and have a width or thickness sufficient to prevent the conduit from being cut or severed when a conduit is crimped therebetween. Additionally, as will be discussed hereinafter with respect to FIGS. 9-11, the crimping members may be formed in alternate configurations. For example, depending on the thickness and material of the walls of the conduit to be crimped, the crimping edges 13 and 21 may be configured to produce a male extension on one crimping edge and female receiver on the second crimping edge in both the long axis and short axis of the face of the crimping edges, so that the conduit walls are crimped into a U-shaped configuration. The U-shaped formation will provide additional obstruction/crimping to the conduit walls.

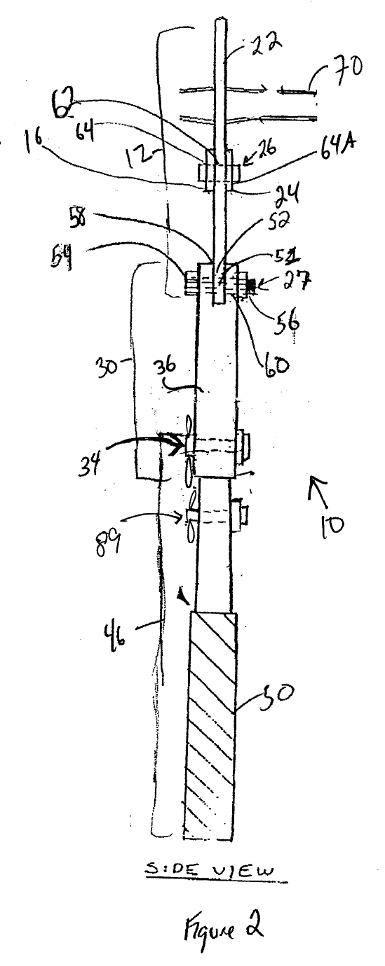

During operation of the tool the first arm 14 and the second arm 22 pivot about the geared area 25 causing the respective hinges 20, 27 to move towards each other and causing the arms 14 and 22 to move away from each other. The plate assembly connects the first arm 14 to the second arm 22 at the geared area 25 and aids in the transfer of force, received from the mid section, to allow for a conduit to be crimped between the crimping edge 13 of the first arm 14 and the crimping edge 21 of the second arm 22. The plate assembly includes a first plate 16 and a second plate 24 both connected to the first arm 14, via a first nut and bolt assembly 18, and to the second arm 22, via a second nut and bolt assembly 26. While a nut and bolt assembly 18 and 26 is described for use in connecting the first plate 16 and second plate 24, any known connection mechanism that allows the crimping members 14 and 22 to pivot about the geared area 25 may be used. The second plate 24 is not shown in FIG. 1 as the second plate 24 is positioned on the opposite side of the tool, as shown in FIG. 2. The arms 14 and 22 are interlocked at their respective geared area 25 and are held together by the plate assembly. The gears 25 are in parallel alignment with the crimping edges 13 and 21 when the crimping edges 13 and 21 are closed and are positioned in contact with one another. The interlocking gears 25 will transfer and reverse the direction of the force received at the connection point between the crimping section 12 and middle section 30 to the crimping edges 13 and 21 of the arms 14 and 22.

The handle section 46 includes a first gripping member 48 connected via a male/female and wing nut assembly 92 to the first leg 32 of the middle section 30. A male/female and wing nut assembly is described for purpose of example only and any connector able to releaseably connect the handle section 46 to the middle section 30 may be used. A second gripping member 50 is connected via a male/female and wing nut assembly 89 to the second leg 36 of the middle section 30. The connection of the gripping members 48, 50 to the middle section 30 by wing nut assemblies 89 and 92 allow the first gripping member 48 and second gripping member 50 to each be selectively removed from the middle section 30 as needed.

Additionally, a swing plate 44 may be engaged to selectively secure the first leg 32 of the middle section 30 to the second leg 36 of the middle section 30 via the wing nut assemblies 33 and 34. The swing plate 44 includes a first end pivotally secured to the second leg 36 by wing nut assembly 34. A second end of the swing plate 44 positioned on a side of the swing plate 44 opposite the first end includes a notch for being selectively received by wing nut assembly 33. When the crimping sections 14 and 22 are fully closed and the conduit is crimped, the notched end of the swing plate 44 is placed around the wing nut and bolt assembly 33. The wing nuts at 33 and 34 are then tightened to secure the swing plate in place. Note that the first end of swing plate 44 is typically loosely attached to leg 36 via the wing nut allowing the swing plate 44 to pivot about the wing nut assembly 34 and is only tightened when the notch at the second end receives wing nut assembly 33. However, the first end of the swing plate 44 may be secured to the second leg 36 by any of a wing nut assembly, a nut and bolt connection and a welded pin connection. This enables the swing plate 44 to remain moveably attached to the second leg 36 which allows for an easier positioning of the notch to be secured by the wing nut assembly 33. The notch at the second end may be positioned on a edge thereof which, when the swing plate 44 is pivoted in a clockwise direction, allows for the notch to be positioned over the bolt of the wing nut assembly thereby preventing any further pivoting thereof. The wing nut may then be rotated thereby bracing the second end of the swing plate between a washer and surface of the first leg 32. When secured, the swing plate 44 prevents the first and second legs 32, 36 from pivoting about pivot 17 and maintains the crimping arms 14, 22 in a closed position. Additionally, the swing plate 44 may be connected on a side of the tool 10 opposite the side which includes the bolt of wing nut assemblies 89 and 92 in order to reduce any interference that may occur when the swing plate 44 is pivoted and rotated in the clockwise direction prior to securing the swing plate 44 in place.

During operation whereby the tool 10 is moved from the closed position to the open position, the gripping members 48 and 50 are moved away from one another. During this operation, hinge 40 moves slightly towards the griping area of the tool forcing hinges 20 and 27 towards each other. As hinges 20 and 27 come together the geared sections of arms 14 and 22 working with the plate assembly 16 and 24 direct the crimping surfaces 13 and 21 apart so they may receive a conduit therebetween. During operation whereby the tool is moved from the open position to the closed position, in an effort to crimp the conduit, the user grips and applies force to the gripping members 48 and 50 so they move towards each other. The force is applied over the handle section 46 and the middle section 30. During this operation, hinge 40 is forced slightly towards the crimping section. This causes hinges 20 and 27 to pivot about hinge 40 away from one another. As hinges 20 and 27 move away from each other, the lower section of arms 14 and 22 at hinges 20 and 27 also move away from each other. As the lower sections of arms 14 and 22 are forced away from each other, the geared section 25 of arms 14 and 22 working with the plate assembly transfer and reverse the force applied on arms 14 and 22 at hinges 20 and 27 to the crimping edges 13 and 21 forcing crimping edges 13 and 21 towards each other. The force transferred to the crimping edges 13 and 21 are applied to the conduit to force the walls thereof in on themselves and close the opening of the conduit thereby preventing any flow of liquid or gas therethrough.

FIG. 2 is a side view of the flow stoppage tool 10 taken along the line labeled 2-2 in FIG. 1. Shown herein are the crimping section 12, the middle section 30 and the handle section 46 which are distinct and separate sections that form the tool 10. Each section of the tool may be manufactured individually and then fit together via the connection methods described herein

This side view shows the second arm 22, first plate 16, second plate 24, second leg 36 and second gripping member 50. However, it should be understood that any description of the features shown in this view also may apply to the first arm 14, first plate 16, second plate 24, first leg 32 and first gripping member 48 as shown in FIG. 1 as the structures on each side of the tool are mirror images of one another.

FIG. 2 shows the connection of the plate assembly to the crimping section 12 of the tool 10. The second arm 22 includes a channel 62 extending therethrough. The first plate 16 and the second plate 24 each include a plate aperture 64 and 64A respectively extending therethrough. The plate apertures 64 and 64A are aligned with the channel 62 and receive the plate hinge 26 for securing the first and second plates 16 and 24 to the second arm 22. The plate hinge 26 may include a nut and bolt assembly or any other mechanism able to mount the plates 16 and 24 to the second arm 22.

The second arm 22 includes a tab 52 extending at an end thereof that is connected to the second leg 36 of the middle section. The tab 52 includes an aperture 51 extending transversely through the tab 52. The second leg 36 includes a slot 58 extending partially therein and a channel 60 extending transversely therethrough. The channel 60 bisects the slot 58 and extends entirely through the second arm 36 of the middle section 30. The tab 52 is received within the slot 58 such that the aperture 51 is aligned with the channel 60 and the second arm 22 is connected to the second leg 36 via the connection hinge 27. The connection hinge may include a nut 54 and bolt 56 or any other mechanism that is able to secure the second arm 22 to the second leg 36. The bolt 56 is inserted into the channel 60 on a first side of the second leg 36 and extends through the channel 60 and the aperture 51.

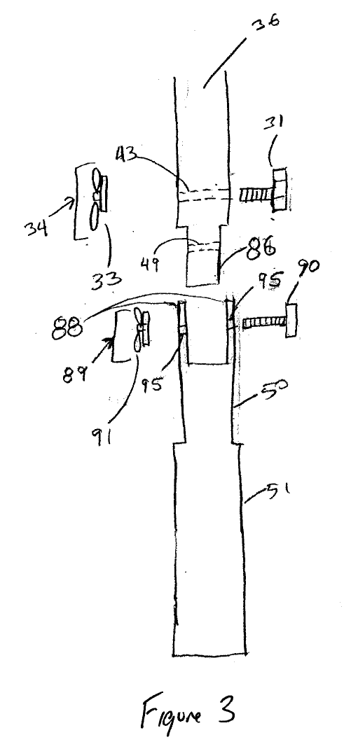

FIG. 3 is an exploded side view of the tool 10 taken along the line labeled 2-2 in FIG. 1. The crimping section 12 is connected to the middle section 30 in the manner discussed above with respect to FIG. 2. FIG. 3 shows the manner of connecting the handle section 46 to the middle section 30. This connection advantageously allows for the selective removal of the handle section 46 as needed to reduce stress on the conduit 70 being crimped by the crimping section 12. Similarly as discussed above with respect to the connection of the crimping section 12 to the middle section 30, all structures described in FIG. 3 as applying to the second leg 36 and second gripping member 50 have corresponding structures on the first leg 32 and first gripping member 48.

The second arm 36 includes a male connector 86 at an end opposite the connection of the middle section 30 to the crimping section 12. The second gripping member 50 has a corresponding female receptor 88 extending into an end thereof. The male connector 86 is received by the female receptor 88 of the second gripping member 50. The male connector 86 includes an aperture 49 extending therethrough. The female receptor 88 includes an aperture 95 extending therethrough. When the male connector 86 is received within the female receptor 88 the aperture 49 is aligned with the aperture 95. A wing nut assembly 89 may be received through the aligned apertures 49 and 95 to secure the second arm 36 to the second gripping member 50. The wing nut assembly 89, which includes a threaded bolt 90 and wing nut 91 releaseably secures the second gripping member 50 to the second leg 36. The threaded bolt 90 is received through the aperture 95 and aperture 49 and partially extends out an opposite side of the gripping member 50. The wing nut 91 is rotatably secured to the threaded bolt 90 thereby releasably securing the handle section 46 to the middle section 30 to provide enough leverage to crimp the conduit 70. While the manner of releaseably connecting the gripping members to the middle section is described as a wing nut assembly, it is also contemplated that the method of releaseably connecting the gripping member may include any of a snap-fit connection, a threaded screw or any mechanism allowing for the gripping members to be releaseably secured to the middle section.

FIG. 4 is a front view of the crimping section 13 of the tool 10. Shown herein are the first arm 14 and the second arm 22 which are secured to one another via the plate assembly 16, shown in shadow as indicated by the dashed lines and second plate assembly 24 which is positioned on an opposite side of the tool 10 as shown above in FIG. 2. In addition the plate assemblies 16 and 24 secure the first and second arms 14 and 22 at the geared area 25.

The geared area 25 is positioned at a base of each respective crimping edge 13 and 21. The geared area 25 is formed from arc-shaped sections having a plurality of teeth extends outward from each of the first arm 14 and the second arm 22. The teeth are etched in the arc-shaped surface to form the gears 25. The first and second members 14 and 22 are positioned facing one another allowing the teeth to mate and allow the first and second members 14, 22 to pivot. During operation, the first and second arms 14 and 22 pivot about the geared area 25 to create a space between the first and second crimping edges 13 and 21. This pivot is facilitated by the shape of each respective crimping arm 14 and 22.

The first and second arms 14 and 22 have a first width at the point of connection to the first and second legs 32 and 36 (FIG. 1), respectively. The width of the arms 14 and 22 gradually increase in direction opposite the connection point to have a second width, greater than the first width, beginning at the base of the crimping edges 13 and 21 each having the arc-shaped sections. The gradual increase in width between the first and second widths enables the crimping members to pivot about the geared section 25 and create an opening between the crimping edges 13 and 21.

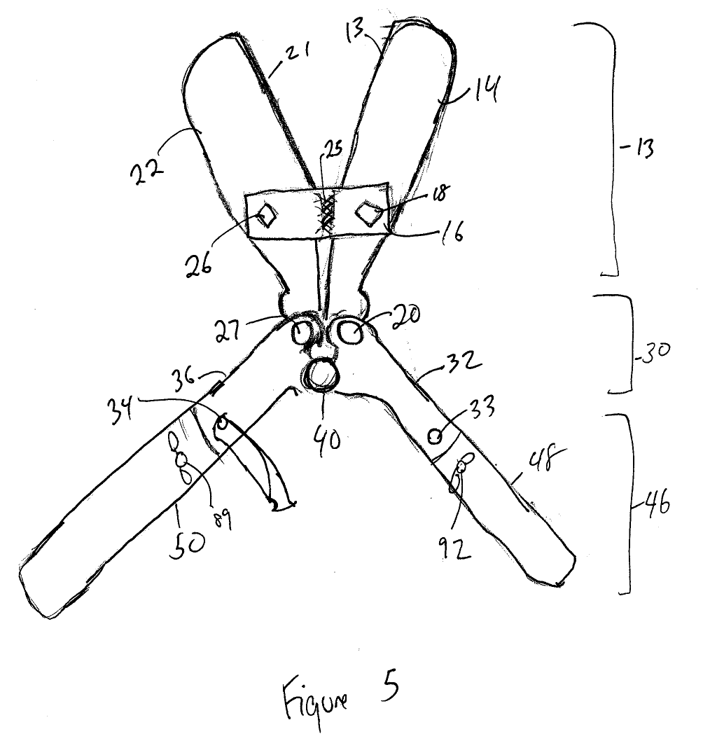

FIG. 5 is a front view of the tool 10 in an open or disengaged position. The gripping members 48 and 50 of the handle section 46 are moved in a direction away from one another. This movement causes the first leg 32 and the second leg 36 to pivot about hinge 40 causing the bolt assemblies 20 and 27 to move toward one another. During this movement, the first crimping arm 14 and second crimping arm 22 pivots about the gears 25 as shown in FIG. 4 to create an opening between the crimping edges 13 and 21 of the arms 14 and 22. The pivot about the gears 25 is facilitated by the bolt assemblies 18 and 26 of the plates 16 and 24.

When the tool 10 is moved from the open or disengaged position as shown herein, to the closed position as shown in FIG. 1, force is applied to the gripping members 48 and 50 causing movement towards one another. The force is applied over the handle section 46 and the middle section 30. During this operation hinge 40, is forced slightly towards the crimping section of the tool so that it is forced between hinges 20 and 27. This transfers and reverses the force applied at the handles to crimping section 12 at connection hinges 20 and 27 and forces hinges 20 and 27 to pivot about the hinge 40 and away from each other. As hinges 20 and 27 move away from each other, the lower section of arms 14 and 22 pivot about the geared area 25 and also move away from each other. As the lower sections of arms 14 and 22 are forced away from each other the geared section 25 of arms 14 and 22 working with the plate assembly transfer and reverse the force applied on arms 14 and 22 at hinges 20 and 27 to the crimping edges 13 and 21 forcing crimping edges 13 and 21 to pivot about the geared area 25 and towards each other. The force transferred to the crimping edges 13 and 21 are applied to the conduit to force the walls thereof in on themselves and close the opening of the conduit thereby preventing any flow of liquid or gas therethrough.

Upon crimping of a conduit, the user can selectively secure the first leg 32 and the second leg 36 of the middle section 30 together using the swing plate 44. The swing plate 44 can pivot about the connection 34 to position the notch over the bolt of the wing nut assembly 33. The wing nut assembly 33 can be selectively tightened to secure the second end of the swing plate 44 having the notch between the nut of the assembly 33 and a surface of the first leg 32. Thereafter, a user may selectively release the nuts of wing nut assemblies 89 and 92 thereby removing the gripping members 48 and 50 from the midsection 30 of the tool 10. This reduces the torque effect that the secured tool 10 has on the conduit being crimped.

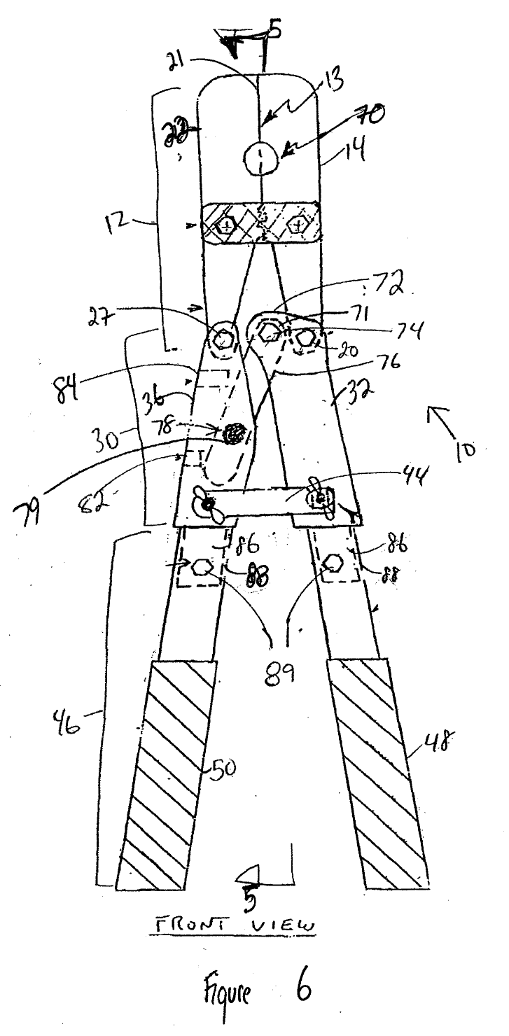

FIG. 6 is a front view of the tool 10 using an alternate mechanism for transferring the force applied at the handle section 46 to the middle section 30 and further to the crimping section 12. The tool 10 includes substantially the same structures and connected in substantially the same manner as the tool 10 shown in FIGS. 1-3. Thus, the description of the tool 10 of FIG. 4 will concentrate on the mechanism used to connect the first leg 32 and second leg 36 to one another to enable a transfer of force to the crimping section sufficient to crimp a conduit positioned therebetween.

The first leg 32 includes a curvilinear tab 72 having a first recess 71 extending therethrough and from an end thereof proximate the connection to the first arm 14 of the crimping section 12. The second leg 36 has an edge that is substantially straight and bowed edge positioned opposite the straight edge. A second recess 79 extends through the second leg 36 proximate the bowed edge thereof. A dowel hinge 78 is received through the second recess 79 of the second leg 36. The second leg 36 further includes a first stop 82 positioned proximate an end connected to the handle section 46 and a second stop 84 positioned proximate an end connected to the crimping section 12. A connection member 76 is pivotally secured between the first recess 71 and second recess 79. Stop 82 and stop 84 are adjustable and maintain the angle of the connection member 76 which in turn maintains the angle of arms 32 and 36. Arms 32 and 36 maintain the angle of arms 14 and 22 of the crimping section 12 relative to each other so that the crimping edges 13 and 21 may close completely when force is applied to handles 48 and 50.

The connection member 76 connects the first leg 32 with the second leg 36. The connection member 76 is connected at a first end via bolt assembly 74 that is received through the first recess 71 on the tab 72 of the first leg 32. The connection member 76 is further connected to the second leg 36 via the dowel hinge assembly 78. During operation whereby the tool is moved from the closed position to the open position, the gripping members 48 and 50 are moved away from one another. During this operation the connection member 76, dowel hinge 78 and bolt assembly 74 act as a hinge assembly between arms 32 and 36 and allow bolt assemblies 27 and 20 to approach each other by displacing bolt assembly 74 towards the griping handle of the tool. As bolt assemblies 20 and 27 come together, the geared sections of arms 14 and 22 direct the crimping surfaces 13 and 21 apart so they may receive a conduit therebetween. During operation, whereby the tool is moved from the open position to the closed position, the gripping members 48 and 50 are moved towards each another. This causes the connection member 76, dowel hinge 78 and bolt assembly 74 act as a hinge assembly between arms 32 and 36 and force bolt assemblies 27 and 20 away from each other by forcing bolt assembly 74 towards the crimping section of the tool and in between bolt assemblies 27 and 20. As bolt assemblies 20 and 27 are forced apart the geared sections of arms 14 and 22 working with the plate assembly transfer and reverse the force applied on arms 14 and 22 at hinges 20 and 27 to the crimping edges 13 and 21 forcing crimping edges 13 and 21 towards each other closing on the conduit positioned therebetween to force the walls of the conduit in on itself.

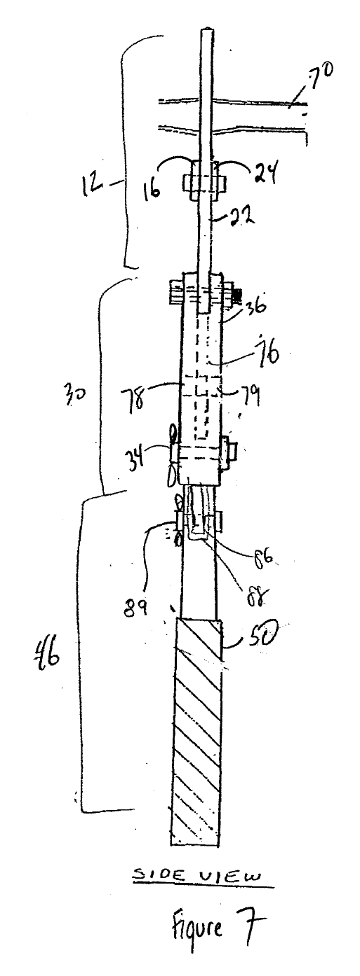

FIG. 7 is a side view of the tool 10 shown in FIG. 6. The side view further shows the various connections for connecting the sections of the tool to one another. The view shown herein is taken along the line labeled 5-5 in FIG. 6 and shows the second arm 22, first plate 16, second plate 24 second leg 36 and second gripping member 50. The second leg 36 includes the recess 79 extending therethrough. The recess 79 receives the dowel hinge 78 for securing the connection member 76 to the second leg 36. As discussed above in FIG. 6, the connection member 76 is pivotally connected to arm 32 by a bolt assembly 74 (FIG. 6).

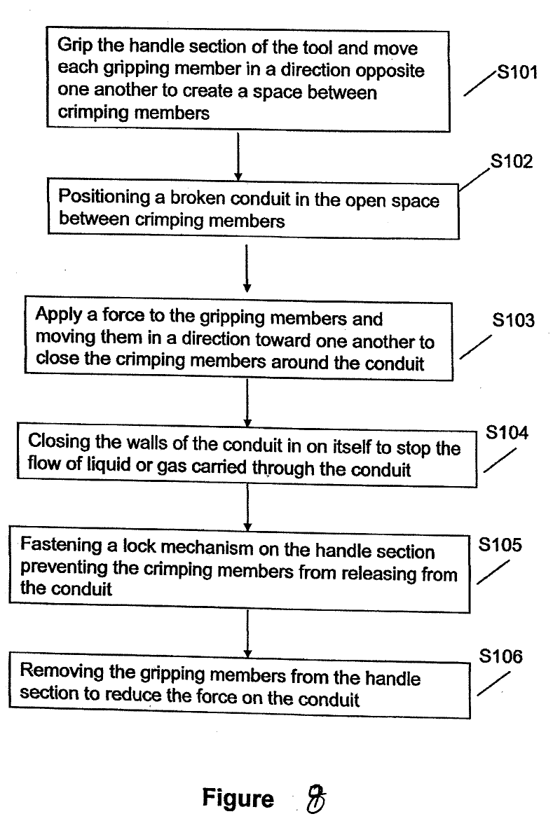

The operation of the tool 10 will now be discussed with respect to FIG. 8. When an undesired flow of liquid or other substance that is flowing through a malleable conduit that is damaged, an emergent need arises to reduce or eliminate the flow of the liquid therethrough. In step S101, the handle section is gripped by a user and each respective gripping member is moved in a direction opposite one another. This causes the crimping members to pivot about their respective pivot points to create an opening between the crimping edges thereof. The user may then position the tool around a conduit that has been damaged as in step S102. The tool is positioned upstream from the damaged section of the conduit. Once positioned, the user applies a force to the gripping members to move them in a direction toward one another causing the crimping members to pivot and crimp the conduit as in step S103. Additionally, or alternatively, a user may be required to repeat steps S102 and S103 depending on the size of the conduit being crimped and the nature of the material that was used to make the conduit. Thus, the arms of the crimping member should be long enough to allow a double crimping action to be performed. Upon the conduit being crimped, the walls of the conduit close in on themselves to stop the flow of liquid or gas therethrough (step S104). To ensure that the conduit remains crimped and the flow of the liquid remains halted, step S105 states that a locking mechanism releaseably secures the handles of the tools together and prevents the tool from being released from the conduit. For example, the locking mechanism may be a swing plate that is secured to one of the legs of the middle section and is manually closed by positioning a hooked or notched end around a threaded pin and tightening down with a washer and wing nut assembly. This manner of locking the handles together is described for purpose of example only and any mechanism that secures the handles together may be implemented. Depending on the weight of the tool and/or the weight of the conduit, a user may selectively remove the individual gripping members from the tool to reduce the torque effect on the conduit as in step S106. The user should hold and secure the tool when the gripping members are pulled away from the middle section to avoid further damaging the conduit.

When the source of the liquid or other material in the pipe is shut down, via a valve or other mechanism, the tool may be removed by reattaching the handles and applying a force to the gripping members to move them in a direction toward one another causing the crimping members to receive the force from the handles. This will allow the notched end of the swing plate to be disengaged after the wing bolt on the notched end of the swing plate is loosened. The release of the locking mechanism will then allow the user to pull apart the gripping handles and remove the tool from the conduit.

FIGS. 9-11 are front views of the alternately shaped crimping members 14 and 22 which form the crimping section 12 of the tool 10. FIGS. 9A, 10A and 11A show the crimping members 14, 22 in a closed or engaged position and FIGS. 9B, 10B and 11B show the crimping members 14, 22 in an open or disengages position. The crimping members 14 and 22 shown in FIGS. 1-7 show the crimping edges as being substantially straight and level. The crimping edges 13 and 21 shown in FIGS. 9-11 each have respective male and female elements which allow for crimping of conduits of different size and thickness. FIGS. 9A and 9B show the crimping edge 13 of the first crimping member 14 as a bow-shaped male element 103 and a corresponding female element 101 on crimping edge 21 of the second crimping member. FIGS. 10A and 10B show the crimping edge 13 of the first crimping member 14 as an angled notched male element 107 and a corresponding female element 105 on crimping edge 21 of the second crimping member. FIGS. 11A and 11B show the crimping edge 13 of the first crimping member 14 as a rectangular male element 109 and a corresponding female element 108 on crimping edge 21 of the second crimping member. Each of the male and female elements shown in FIGS. 9-11 are described for purposes of example only. The crimping members 14 and 22 can be formed with crimping edges 13 and 21, respectively, in any shape that can be used to effectively stop the flow of liquid or gas through a conduit when used in conjunction with the operation of the tool 10.

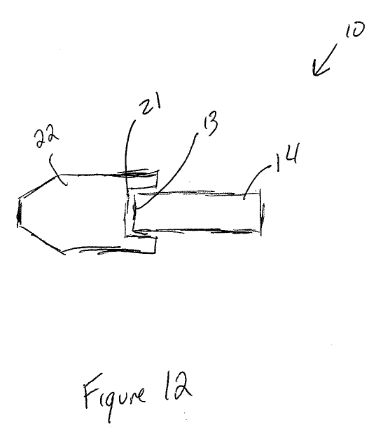

FIG. 12 is a cross-sectional view of the crimping section of the tool 10 taken along the line labeled X-X in FIGS. 9-11. The first arm 14 and second 22 of the crimping section 12 may have respective male and female crimping edges 13 and 21. In this Figure, the second arm 22 is shown having a female crimping edge 21 including a recess for receiving the male crimping edge 13 of the first arm 14. Alternatively, the first arm 14 may include a female crimping edge 13 for receiving a male crimping edge 21 of the second arm 22. Additionally, as discussed above the crimping edges 13 and 21 may be flat and have a surface area sufficient to prevent a conduit positioned therebetween from being cut or severed. Upon operating the tool as discussed above, a conduit (not shown) may be crimped between the first edge 13 and the second edge 21. The configuration shown herein further improves the seal formed when the conduit is crimped by the crimping section. The walls of the conduit are caused to have a U-shaped seal which provides an enhanced seal for stopping and/or reducing the flow of liquid and/or gas flowing through the conduit. The male-female connection across the horizontal axis of the crimping section 12 maybe be applied and used with any of the crimping sections shown in FIGS. 1-11.

The tool described in FIGS. 1-12 will be inexpensive to manufacture and is intended for use by users having minimal training. The tool may be used to halt the flow of a plurality of different liquids and or gases (depending on temperature, pressure and combustibility) in any conduit made from a malleable material. The tool will find uses in various types of buildings, homes, boats, ships and on machines and may be used by contractors, maintenance personnel, facility engineering departments, property management personnel and the lay person.

It will be understood that each of the elements described above, or two or more together may also find a useful application in other types of devices differing from the type described above.

While certain novel features have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

I claim:

1. A tool for reducing a flow of liquid or gas through a conduit comprising:
a crimping section comprising
a first crimping member having a first blunt section extending partially along an edge thereof, and
a second crimping member having a second blunt section extending partially along an edge thereof, said first blunt section and said second blunt section having a surface area able to prevent cutting an objection positioned therebetween and said first and second members being pivotally engaged with one another;
a handle section comprising
a first handle member connected to said first crimping member, and
a second handle member connected to said second crimping member; and
a connector pivotally connecting said first handle member to said second handle member, whereby when said first and second handle members are pivoted about said connector, said first and second crimping members are caused to pivot in a direction opposite to said respective first and second handle members.

2. The tool as recited in claim 1 further comprising first and second plate assemblies positioned on opposing surfaces of said crimping section for securing engagement between said first and said second crimping members.

3. The tool as recited in claim 1, wherein each of said first and second crimping members having a first section positioned between said connection to said handle section and said blunt section, said first section having a width which increases gradually from a point of connection with said respective handle member to a first end of respective blunt section.

4. The tool as recited in claim 3, wherein each of said first and second crimping members further include
a geared section positioned between said first section and said first blunt section of said crimping member, said geared sections of said first and second crimping members being engaged with one another and allowing said first and second crimping members to pivot thereabout.

5. The tool as recited in claim 4, wherein
said geared section of each of said first and second crimping members are arcuate in shape and have a plurality of teeth for engaging teeth on the other of said geared section.

6. The tool as recited in claim 1, wherein said handle section further comprises
a middle section, said middle section comprising
a first leg,
a second leg, and
said connector, said connector pivotally connecting said first leg to
said
second leg; and
a gripping section, said gripping section comprising
a first gripping member releasbly secured to said first leg; and
a second gripping member releasably secured to said second leg.

7. The tool as recited in claim 6, wherein each of said first and second gripping members are connected to said respective one of said first and second legs by a wing nut assembly.

8. The tool as recited in claim 1, further comprising a securing mechanism for releasably securing said first gripping member to said second gripping member when said tool is in a closed positioned.

9. The tool as recited in claim 8, wherein said securing mechanism comprises:
a swing plate having a first end rotatably connected to said first gripping member and a second end, opposite said first end having a notch; and
a wing-nut assembly having a bolt and wing nut extending through said second gripping member, notch releasably receiving said bolt and said wing nut assembly releasably securing said second end to said second gripping member when received in said notch.

10. The tool as recited in claim 1, wherein said first blunt section includes a protrusion extending along its length and said second blunt section includes a recess extending along its length for selectively receiving said shaped extension of said first crimping member.

11. The tool as recited in claim 1, wherein said first blunt section includes a protrusion extending along a vertical axis thereof having at least one of an arcuate shape, an angled notch shape and a rectangular shape and said second blunt section includes a recess extending along a vertical axis thereof having a shape able to receive said shaped extension on said first crimping member.

12. The tool as recited in claim 1, further comprising a first bolt assembly for pivotally connecting said first crimping member to said first handle member and a second bolt assembly for pivotally connecting said second crimping member to said second handle member.

13. The tool as recited in claim 1, wherein said connector is a hinge.

14. The tool as recited in claim 1, wherein said connector comprises:
a connection bar pivotally connected at a first end to said first handle member adjacent the connection to said first crimping member and pivotally connected at a second end opposite said first end to said second handle member at a distance from the connection to said second crimping member;
a first stop positioned on said second handle member adjacent said second end of said connection member; and
a second stop positioned on said second handle member between said first stop and said connection of said second handle member to said second crimping member,
said connection bar moveable between a first position in which said second end of said connection bar is positioned adjacent said first stop and said first and second blunt edges are positioned adjacent one another and a second position in which said second end of said connection bar is positioned adjacent said second stop and said first and second blunt sections are spaced apart for receiving a conduit therebetween.

15. The tool as recited in claim 14, wherein said connection bar includes a channel and said second handle member includes a recess aligned with said channel at least partially extending therethrough, said pivotal connection of said connection bar to said second handle member includes a dowel received through said channel and by said recess.
